(19) United States
(12) Patent Application Publication
(10) Pub. No.: US 2019/0368023 A1
(43) Pub. Date: Dec. 5, 2019

(54) PLASMA SPRAYING METHOD FOR COATING A CYLINDER BARREL OF A CYLINDER CRANKCASE OF A RECIPROCATING INTERNAL COMBUSTION ENGINE

(71) Applicant: Volkswagen Aktiengesellschaft, Wolfsburg (DE)

(72) Inventor: Klaus KLIMEK, Bovenden (DE)

(73) Assignee: Volkswagen Aktiengesellschaft, Wolfsburg (DE)

(21) Appl. No.: 16/425,082

(22) Filed: May 29, 2019

(30) Foreign Application Priority Data
May 29, 2018 (DE) 10 2018 208 435.1

(51) Int. Cl. C23C 4/134; C23C 4/08; C23C 4/137; C23C 4/02; C22C 38/40

(52) U.S. Cl. CPC C23C 4/134; C23C 4/08; F02F 7/0085; C23C 4/02; C22C 38/40; C23C 4/137

(57) ABSTRACT

A plasma spraying method for coating a cylinder barrel of a cylinder crankcase of a reciprocating internal combustion engine. A coating method is provided, with the aid of which the formation of oxides is limited or oxide banding in the layer formation and thus negative influences are avoided due to oxidation outbreaks and microgroove formation are avoided. The coating is applied to the cylinder barrel of the cylinder crankcase at least partially using the following parameter combination: rotational speed: 600 to 800 revolutions/minute; sprayed material delivery rate: 80 to 180 grams/minute; and feed rate: 24 to 75 mm/s.

This nonprovisional application claims priority under 35 U.S.C. § 119(a) to German Patent Application No. DE 10 2018 208 435.1, which was filed in Germany on May 29, 2018, and which is herein incorporated by reference.

### BACKGROUND OF THE INVENTION

### Field of the Invention

The present invention relates to a plasma spraying method for coating a cylinder barrel of a cylinder crankcase of a reciprocating internal combustion engine.

### Description of the Background Art

A coating method for coating a curved surface, a thermal coating as well as a cylinder having a thermal coating are known from WO 2017/202852 A1. In particular, reference is made to the use of powdery coating material, using a thermal spraying device, in particular a plasma spraying device or an HVOF spraying device, comprising a burner, which is rotated on a burner shaft around a shaft axis at a predefined rotation frequency, the coating jet being directed at least partially radially away from the shaft axis toward the curved surface to apply a coating to the curved surface. Reference is made to the use of increased rotation frequencies of more than 200 revolutions/minute (rpm), in particular up to 800 rpm or even more, the delivery rate of the powdery coating material being intended to be “suitably increased” accordingly.

The document WO 2017/202852 A1 makes no reference to the feed rate during the coating and also does not address the so-called oxide banding of the coating to be achieved.

In manufacturing cylinder crankcases for reciprocating internal combustion engines, attempts are increasingly made to reduce the weight of the cylinder crankcase. Cylinder crankcases made from aluminum are used for this purpose, which, however, require a protective coating in the area of the cylinder barrel, e.g. a protective coating applied with the aid of plasma spraying. In addition to an increase in robustness of the cylinder barrel, a positive side effect of the coating is a significantly reduced friction in the area of the piston group (and thereby also a reduced CO₂ emission) as well as positive effects with respect to corrosive media. Coating methods known from the prior art are powder plasma spraying (APS method), wiring spraying, such as plasma transferred wire arc (PTWA/RSW) coating, arc wire spraying (AWS) and high-velocity oxygen spraying (HVOF spraying).

Before a thermal coating of cylinder bores in crankcases made from aluminum and partially also from gray cast iron, an abrasion process is carried out and is necessary to interlock the coating, i.e. improve the adherence of the coating, so that the coating may be applied at all. This abrasion process is represented by blasting processes using corundum and water (medium-pressure/high-pressure water jets), laser beam abrasion or abrasion with a geometrically defined cutting edge.

If powder plasma spraying (APS method) is used, an increased oxide formation occurs in inhomogeneous areas caused by the aforementioned abrasion process, if a process control according to a coating operation known from the prior art having, for example, 4 double cycles is selected. This may result in an oxide banding in the coating, which occurs in parallel to the surface. The oxide banding, in turn, causes a reduced layer stability and may result in an oxidation outbreak on the surface of the coating (cylinder barrel) and subsequently in a microgroove formation on the cylinder barrel surface, in particular in the presence of oxides/oxide bands, after final honing. If the oxides/oxide bands on the surface are stressed by the honing process, increased oxidation outbreaks of this type may occur and thus an increased pore area proportion of the barrel surface. This may result in greater oil consumption and thus correspondingly to an increased particle emission. Another disadvantage of the method known from the prior art is that it requires a relatively great amount of time for the coating operation.

### SUMMARY OF THE INVENTION

It is therefore an object of the present invention to provide a coating method, with the aid of which the formation of oxides is limited or oxide banding in the layer formation and thus negative influences due to oxidation outbreaks and microgroove formation—in particular, resulting from such oxidation outbreaks or existing due to a high oxide banding—are avoided.

According to the plasma spraying method according to the invention for coating a cylinder barrel of a cylinder crankcase of a reciprocating internal combustion engine, the coating is applied to the cylinder barrel of the cylinder crankcase at least partially using the following parameter combination:

a) Rotational speed: 600-800 rpm;
b) Sprayed material delivery rate: 80-180 g/min; and
c) Feed rate: 24-75 mm/s.

With the aid of extensive empirical test series and taking into account modified machinery, it was ascertained that the formation of oxides may be minimized and the occurring oxide banding may be reduced with the aid of the aforementioned parameter ranges, all of which must be fulfilled according to a), b) and c) in order to achieve the advantages according to the invention. A particularly homogeneous surface may be achieved thereby, which is largely free of an undesirable microgroove formation, which occurs due to an increased oxide formation and a high oxide banding. In addition, a high rotational speed may be used during the method, and thus the desired coating may be applied in a shorter amount of time than using the methods known up to now from the prior art. With respect to the rotational speed of the burner system, values between 600 and 700 rpm have proven to be preferred. Values between 630 rpm and 770 rpm, are furthermore preferred, values between 640 rpm and 660 rpm being particularly preferred. Particularly good results were achieved at rotational speeds of 650 rpm.

With regard to the sprayed material delivery rate, reference is made, in particular, to the narrower value range between 80 g/min and 150 g/min. The value range between 90 g/min and 130 g/min is further preferred, and the value range between 100 g/min and 120 g/min is particularly preferred. With regard to the sprayed material delivery rate, special reference is made to the value of 110 g/min, with the aid of which a particularly high-quality result of a coating of the cylinder barrel was achieved, in particular in connection with the rotational speed of 650 rpm.

With regard to the feed rate according to feature c), reference is made to the value range between 30 mm/s and 70 mm/s, more preferably to the value range between 40 mm/s and 65 mm/s and particularly preferably to the value range between 50 mm/s and 65 mm/s. Moreover, reference is made to the even narrower value range between 52 mm/s and 60 mm/s and more preferably between 54 mm/s and 58 mm/s.

In one practical specific embodiment of the plasma spraying method according to the invention, the coating is applied with the aid of 5 to 8 spray cycles in the form of double strokes. The application with the aid of 6 to 7 spray cycles should be particularly preferably mentioned in this regard. It has been shown that the thickness and structure of a corresponding coating in connection with the processing duration needed in each case is particularly high-quality and efficient in this case.

A steel layer or a ceramic layer is preferably applied as the coating. With regard to the steel layers, references is made, in particular, to low-alloy and high-alloy steel layers, i.e. to steel layers having steels in which the sum of the alloy elements does not exceed a content of 5 percent by mass (low-alloy steels), or steels in which the average mass content of at least one alloy element is greater than or equal to 5% (high-alloy steels). The use of low-alloy steels is preferable to that of high-alloy steels. However, results are also achieved with high-alloy steels which are advantageous compared to the results known from the prior art.

With regard to the application of a ceramic layer, reference is made, in particular, to layers made from titanium dioxide (TiO₂).

Independently of the above, a ceramic layer is preferably applied in connection with a prior abrasion process and the prior application of an adherence-promoting layer. In particular, a nickel aluminum layer, a bronze layer or a low-alloy steel layer may be considered as the adherence-promoting layer. The thickness of an adherence-promoting layer is advantageously less than 100 μm, preferably less than 60 μm and particularly preferably a maximum of 40 μm.

If a coating in the form of a low-alloy steel layer is to be achieved in a plasma spraying method according to the invention, this coating is preferably applied with the aid of a low-alloy steel powder. Steel powders having a predominantly spherical morphology with small proportions of satellites would be particularly preferred.

In another practical specific embodiment of a plasma spraying method according to the invention, in which a steel layer is applied as the coating, the coating is applied with the aid of a steel powder, which has less than 2 wt % carbon (C), less than 2 wt % manganese (Mn), less than 2 wt % chromium (Cr), less than 1 wt % nickel (Ni), less than 1 wt % oxygen (O₂) and less than 1 wt % nitrogen (N₂). With respect to the fraction of carbon, reference is made, in particular, to a fraction of 1.0 wt % to 1.3 wt %. With respect to the fraction of manganese, reference is made, in particular, to a fraction of 1.2 wt % to 1.6 wt %. With respect to the weight fraction of chromium, reference is made, in particular, to a value range from 1.2 wt % to 1.6 wt %. With respect to the weight fraction of nickel, reference is made, in particular, to a value range of less than 0.5 wt %. With respect to the weight fraction of oxygen, references is made, in particular, to values of less than 0.2 wt %, and with regard to the weight fraction of nitrogen, reference is made, in particular, to the value range of less than 0.5 wt %. The aforementioned value ranges are preferably cumulative, i.e. they are linked to each other in this combination.

A particularly high-quality coating results if a steel layer is applied with the aid of a steel powder whose grain size is exclusively smaller than 60 μm and/or whose grain size is to a very large extent smaller than 42 μm. The fraction in weight percent of steel powder having a grain size smaller than 42 μm is preferably a maximum of 90 percent. The fraction having a grain size smaller than 26 μm is preferably a maximum of 50 percent. The fraction having a grain size smaller than 16 μm is preferably a maximum of 10 percent.

In another practical specific embodiment of a plasma spraying method according to the invention, the coating is applied under the influence of the atmosphere. In this case, the method is also referred to as atmospheric plasma spraying or the APS method. One advantage of the APS method is that the use of protective gases and the additional costs associated therewith may be dispensed with. Alternatively, in a plasma spraying method according to the invention the coating may also be applied using a protective gas or in a vacuum. In this case, while the cost of carrying out the method is increased, in the individual case, however, an even much higher-quality result of a coating may be achieved, i.e., in particular a coating may be achieved, which has a lower oxide fraction or a lower oxide banding.

The plasma spraying method according to the invention is advantageous, in particular, if at least one blasting abrasion process is carried out before the coating is applied, using corundum and/or water, by means of laser beam abrasion or by abrasion with the aid of a geometrically defined cutting edge. In this case, the adherence of the coating to be applied is improved, and the durability of the coating achieved is simultaneously increased.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a cross-sectional representation of a detail of a cylinder barrel having a coating;

FIG. 2 shows a view of a surface of a coating of a cylinder barrel according to the prior art;

FIG. 3 shows a cross section of a coating on a cylinder barrel manufactured using a method according to the invention; and

FIG. 4 shows an enlarged representation of the detail according to FIG. 3.

### DETAILED DESCRIPTION

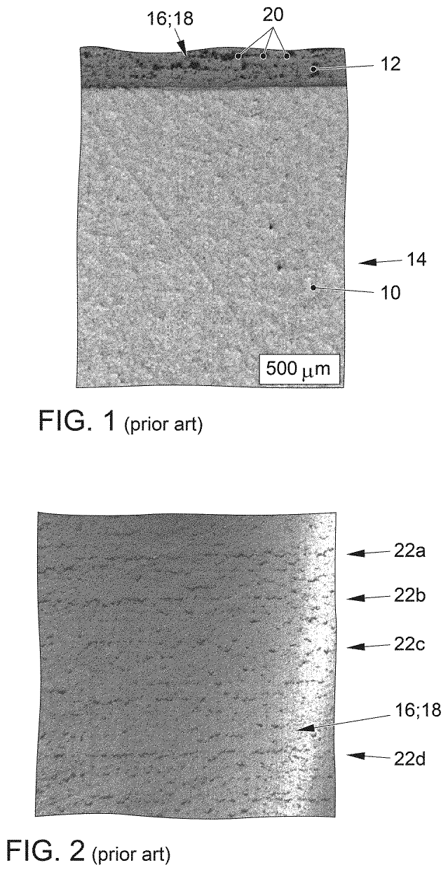

FIG. 1 shows a detail of a cylinder crankcase of a reciprocating internal combustion engine, including a detail of a cylinder barrel of an aluminum base body 10 of a cylinder crankcase 14, aluminum base body 10 being provided with a coating 12, and surface 16 facing away from aluminum base body 10 being part of cylinder barrel 18 of cylinder crankcase 14. Areas 20 partially marked in black are oxides, which have formed during the application of coating 12 with the aid of a plasma spraying method.

FIG. 2 shows surface 16 of cylinder barrel 18. As is apparent in the figure, individual oxide bands 22a, 22b, 22c, 22d have formed on surface 16, which are formed by black dots, which are arranged approximately in a row. This is the oxide banding mentioned at the outset.

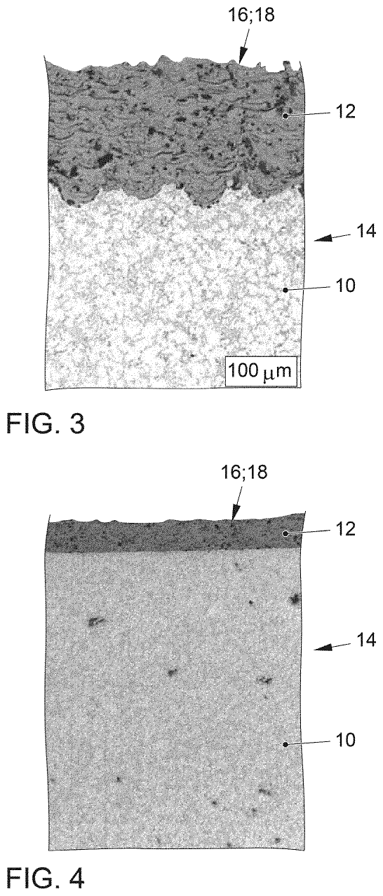

FIG. 3 shows a view similar to FIG. 1, coating 12 having been applied with the aid of a plasma spraying method according to the invention.

FIG. 4 shows an enlarged representation of the view from FIG. 3. As is apparent, surface 16, which forms cylinder barrel 18 of cylinder crankcase 14, has a much higher quality, in that the oxide banding is no longer apparent. Moreover, it is apparent that much less oxide has formed in coating 12 than in coating 12 according to the prior art, which is illustrated in FIG. 1.

The invention being thus described, it will be obvious that the same may be varied in many ways. Such variations are not to be regarded as a departure from the spirit and scope of the invention, and all such modifications as would be obvious to one skilled in the art are to be included within the scope of the following claims:

What is claimed is:

1. A plasma spraying method comprising:
coating a cylinder barrel of a cylinder crankcase of a reciprocating internal combustion engine; and
applying the coating, at least partially, to the cylinder barrel of the cylinder crankcase using the following parameter combination:
rotational speed: 600 to 800 revolutions/minute;
sprayed material delivery rate: 80 to 180 grams/minute; and
feed rate: 24 to 75 mm/s.

2. The plasma spraying method according to claim 1, wherein the coating is applied with the aid of 5 to 8 spray cycles, in the form of double strokes in each case.

3. The plasma spraying method according to claim 1, wherein a steel layer or a ceramic layer is applied as the coating.

4. The plasma spraying method according to claim 1, wherein the coating is applied with the aid of a low-alloy steel powder.

5. The plasma spraying method according to claim 1, wherein a steel layer is applied as the coating with the aid of a steel powder having a predominantly spherical morphology with small proportions of satellites.

6. The plasma spraying method according to claim 1, wherein a steel layer is applied as the coating with the aid of a steel powder, which has less than 2 wt % carbon (C), less than 2 wt % manganese (Mn), less than 2 wt % chromium (Cr), less than 1 wt % nickel (Ni), less than 1 wt % oxygen (O₂) and less than 1 wt % nitrogen (N₂).

7. The plasma spraying method according to claim 1, wherein a steel layer is applied with the aid of a steel powder whose grain size is smaller than 60 μm or is smaller than 42 μm.

8. The plasma spraying method according to claim 1, wherein the coating is applied under the influence of the atmosphere (APS method).

9. The plasma spraying method according to claim 1, wherein the coating is applied using a protective gas or in a vacuum.

10. The plasma spraying method according to claim 1, wherein at least one blasting abrasion process is carried out before the coating is applied, using corundum and/or water, via laser beam abrasion or by abrasion with the aid of a geometrically defined cutting edge.
